(19) United States
(12) Patent Application Publication
(10) Pub. No.: US 2015/0310841 A1
(43) Pub. Date: Oct. 29, 2015

(54) DEVICE FOR MONITORING USE ACCURACY OF PERCUSSION INSTRUMENTS

(71) Applicant: Alberto SEMENZATO, Noale (VE) (IT)

(72) Inventor: Alberto SEMENZATO, Noale (VE) (IT)

(21) Appl. No.: 14/647,950

(22) PCT Filed: Nov. 26, 2013
(86) PCT No.: PCT/EP2013/074700

§ 371 Date: May 28, 2015

(30) Foreign Application Priority Data
Nov. 28, 2012 (IT) MI2012A002019

(51) Int. Cl. G10D 13/02

(52) U.S. Cl. CPC G10D 13/029

(57) ABSTRACT

A device (1) for monitoring the use accuracy of percussion instruments (5) which includes a sensor (3) intended to detect musical data (T, I) from said instrument (5), an electronic device (9) adapted to sample at a sampling frequency Fc the musical data (T, I) detected by said sensor (3), which comprise the instant (T), detected with respect to an initial instant T0 taken as a reference, and the intensity (I) of each stroke that reaches the percussion instrument (5) during an execution of a musical score (PMS) played by a user (100), and adapted to store said musical data (T, I) in a memory device (11). An external computing device (19) having a database (50) containing at least one musical sample score (PMC) intended to be considered as a reference score, or a microprocessor (6) comprised in the electronic device (9), compares the musical data (T, I) detected by the sensor (3) during the execution of a played musical score (PMS) by a user (100) with the corresponding musical data (Tc, Ic) of the musical sample score (PMC), and provides the deviation between the measured musical data (T, I) of the played musical score (PMS) and the corresponding ones (Tc, Ic) of the musical sample score (PMC).

The present invention relates to a device for monitoring and evaluating the accuracy of the execution of musical scores played on percussion instruments.

During the execution of a musical score, in particular using percussion instruments, it is essential that the notes played by the player are in agreement with the dictates of the score both in the temporal location and in the intensity.

Devices have already been proposed for monitoring the execution of a musical score integrated with percussion instruments which, when one or more beats reach generally electronic instruments, graphically display them, for example on a screen or a display. Such devices may be provided with loudspeakers for playing a guide musical “arrangement” which the user can use as a reference in performing musical scores, imitating what has been heard and visually aiding with what is displayed on the screen. The systems described above often have the drawback of being more similar to a game than to a measurement device, as they do not allow an a posteriori or real-time analysis of the accuracy of the execution of the musical score played and do not provide an evaluation report accurate enough to be useful for the needs of professional musicians. Even the most advanced types of devices among those described, moreover, do not have an accuracy and a sensibility in the detection of beats which can justify the comparison to a measuring device.

Other known types of device for monitoring the execution of musical scores played on percussion instruments are integrated on practice pads (also said drum pads); however, in general, these allow the execution and monitoring of predefined and elementary exercises, thus not allowing the monitoring and the evaluation of the execution of real musical scores and/or of scores of arbitrary complexity.

U.S. Pat. No. 6,545,207 B2 describes an electric machine able count the beats executed on a drum. In order to detect the strokes, such a machine uses a piezoelectric sensor placed on the head of the drum, and then counts the number of strokes detected and displays it on a display. The device described in this patent has the drawback of providing only the number of strokes played on to the monitored drum in a certain period of time, without giving any information about the temporal location and the intensity of these strokes.

EP 1 029 565 A2 (KONAMI CO LTD [JP]) 23 Aug. 2000 describes a process and apparatus for reproducing musical games by taking them from a readable memory support. Said apparatus has openly the function of game: the user/player can indeed simulate a musical execution by means of false rubber drums, included therein, imitating the movements made by a musician during the execution of a musical piece reproduced by the device. The described system, by reproducing sound and view effects, both during and after the execution, will enjoy the user making him compliments if he has “played” well. The interaction modes of the user with the apparatus and the feedback produced thereby are indeed created with the purpose of enjoying the user.

The known just described device shows the drawback that it is not able to give scientific indications, as for example statistic reports, relating to the execution of the piece by the user. Moreover, during the execution of a piece the user will not have the possibility of selecting the metronomic time for the execution of the piece (feature necessary during the regular process of musical learning which generally occurs by passing from slower executions to faster executions) and even less that of deciding to play a particular musical piece by reading a score, because the game described in EP 1 029 565 A2 does not arise for teaching a musician (independently from its degree of preparation), but for enjoying any type of user, interested or not to the music.

It would be desirable to have a device for monitoring and evaluating the accuracy of the execution of musical scores for percussion instruments free from the above drawbacks.

The main object of the present invention is to provide a device for monitoring and evaluating the accuracy of the execution of musical scores for percussion instruments able to provide, almost in real time, information relating to both the temporal location and the intensity of the strokes executed by a user on a percussion instrument during the execution of a score taken as a reference.

Another important object of the present invention is to provide a device for monitoring and evaluating the accuracy of the execution of musical scores for percussion instruments able to provide quality and quantity indicator scores related to the goodness of an execution of a musical score, when this is compared with a score taken as a reference and/or with executions of the same score previously performed.

Last but not least, an object of the present invention is to provide a device for monitoring and evaluating the accuracy of the execution of musical scores for percussion instruments which is easy to use and cost-effective.

According to the invention, such an object is achieved with a device for monitoring and evaluating the accuracy of the execution of musical scores for percussion instruments which includes the features defined in claim 1 or 2.

The invention also consists in a method for monitoring and evaluating the performance of musical scores executed on percussion instruments, which includes the features defined in claim 8.

These and other features of the present invention will appear more clearly from the following detailed description of a practical embodiment thereof, shown by way of a non-limiting example in the accompanying drawings, in which:

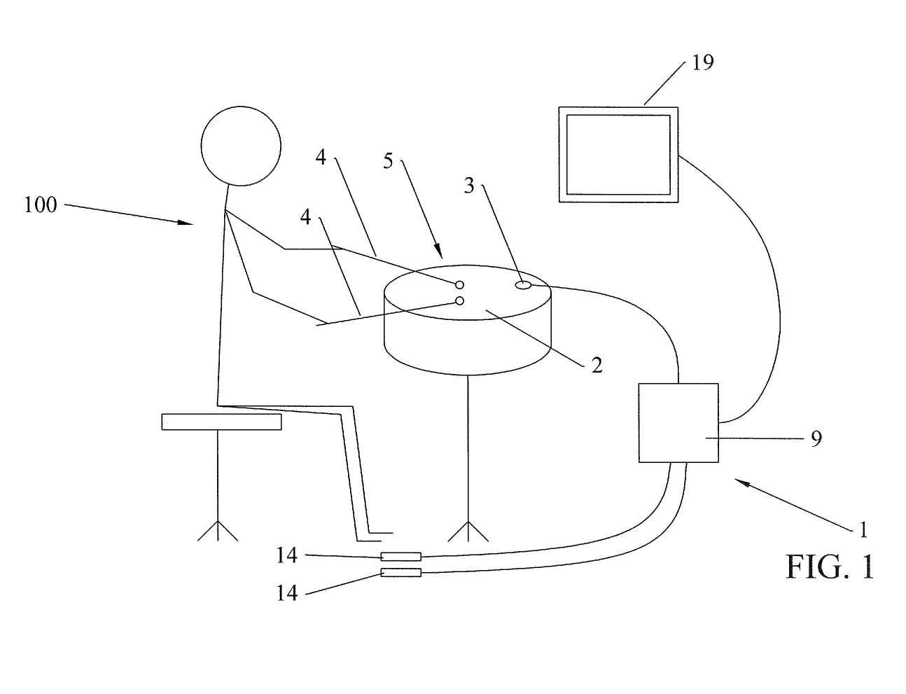

FIG. 1 shows a diagrammatic perspective lateral view of a first example of embodiment of the device according to the present invention for monitoring and evaluating the execution of musical scores played on percussion instruments in use by a user;

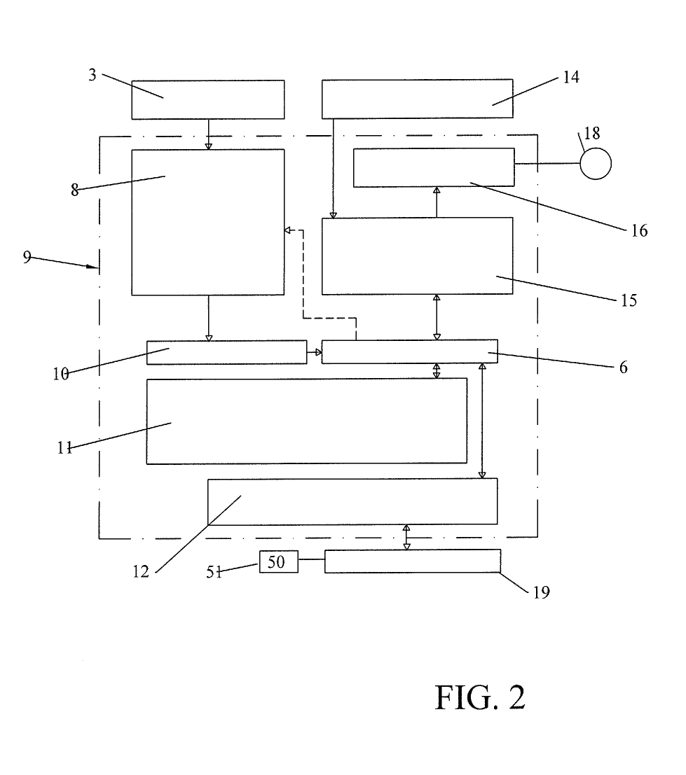

FIG. 2 shows a block diagram of the hardware of the device in FIG. 1;

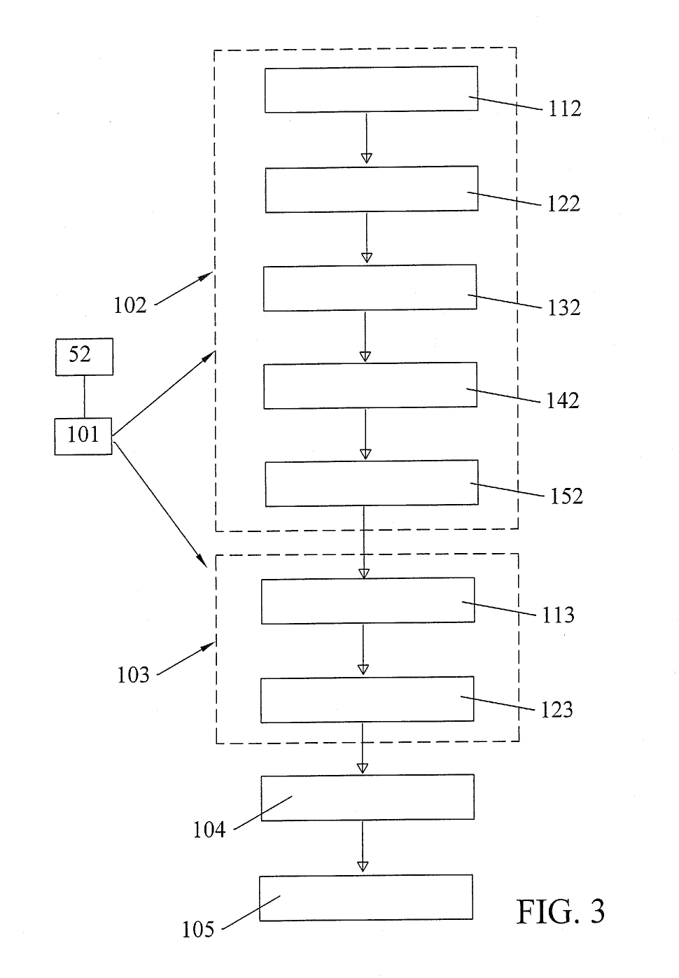

FIG. 3 shows a block diagram of the procedure used by the device in FIG. 1;

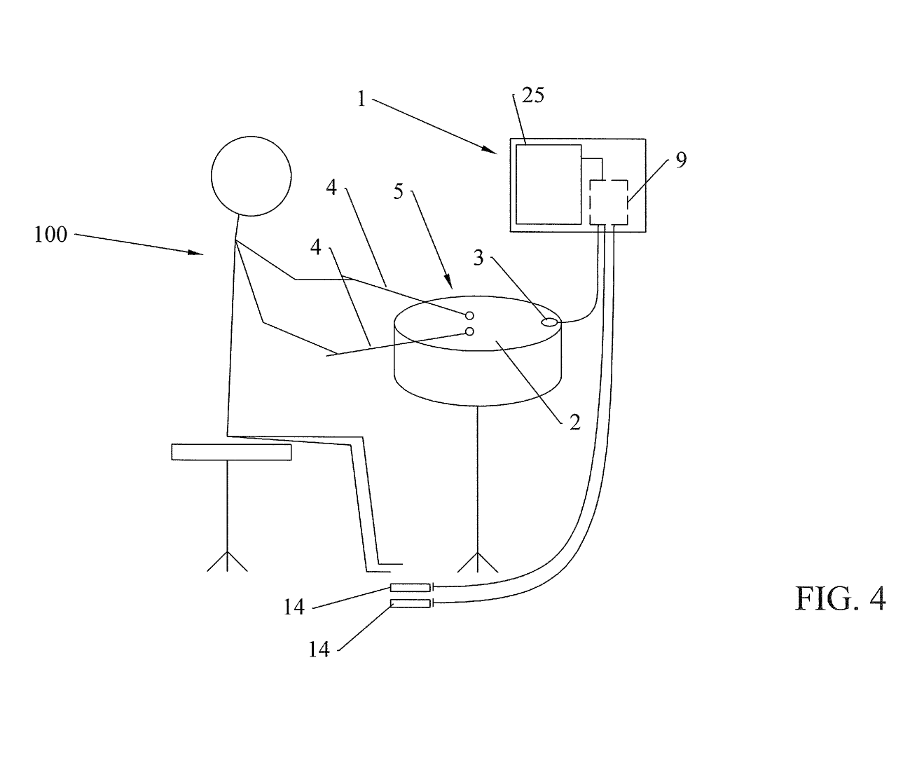

FIG. 4 shows a diagrammatic perspective lateral view of a second example of embodiment of the device according to the present invention for monitoring and evaluating the execution of musical scores played on percussion instruments in use by a user; and

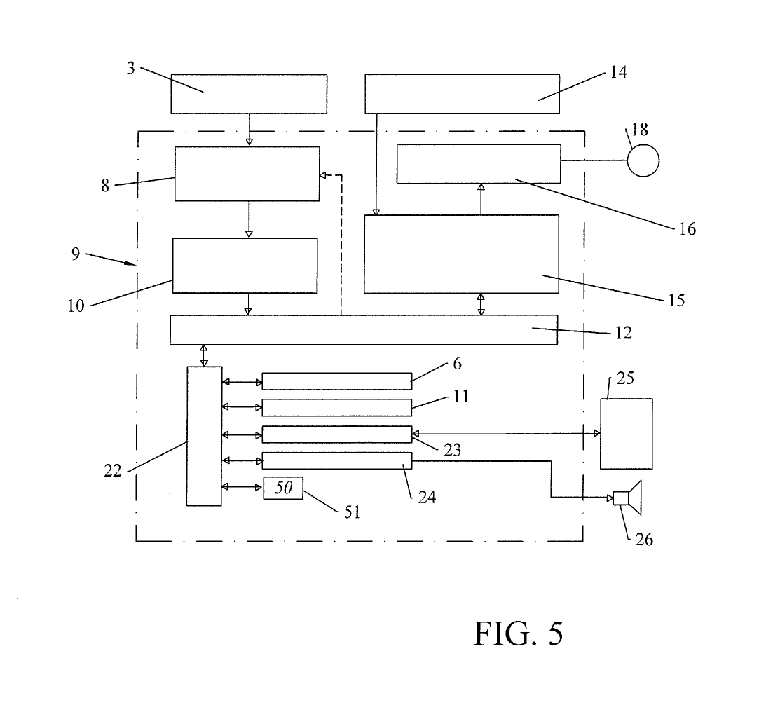

FIG. 5 shows a block diagram of the hardware of the device in FIG. 4.

With reference to FIG. 1, it will be seen that, in a first preferred embodiment, device 1 for monitoring the use accuracy of a percussion instrument 5 includes a sensor 3 for detecting the strokes played with beaters 4 on a percussion surface 2 to which said sensor 3 is coupled. Preferably, sensor 3 will be a piezoelectric sensor or a capacitive microphone or other suitable sensor of known type. The percussion instrument 5 may be a drum, a cymbal, timpani or any other percussion instrument whose physical features are suitable for the application of sensor 3.

Sensor 3 for detecting the strokes is connected to an electronic device 9, which is shown in the form of a block diagram in FIG. 2, where it is seen that sensor 3 is connected upstream of an analog signal conditioning stage 8, in turn upstream of an A/D (Analogic/Digital) converter 10 connected in input to a microprocessor 6 adapted to sample and process the musical data at a sampling frequency Fc. The latter microprocessor 6 has a memory unit 11 intended, among other things, to store the data detected by means of sensor 3 for the necessary time. Said sensor 3, detecting the stroke played on the percussion surface 2, will allow the detection, with respect to an initial instant T0 taken as zero, of instant T in which the beat reached the percussion surface 2 and intensity I of the vibration produced by the impact.

As will be seen in FIG. 2, microprocessor 6 is provided with an I/O (Input/Output) interface 12 of known type, such as USB, Wi-Fi or Bluetooth, to allow the exchange of data between microprocessor 6 itself and a computing device 19, external to device 9 (FIG. 1). In the preferred version of device 1, microprocessor 6 will have basic functions, including I/O management, data acquisition, storage and transmission, while complex calculations may be delegated to the computing device 19 (Personal Computer, Tablet, Notebook or other), in turn connected to the electronic device 9 through interface 12.

A remote control 14 is connected in input to microprocessor 6, through a digital signal conditioning stage 15, to send a start/stop control. Preferably, the remote control 14 will be a switch or pedal button (FIG. 1) or any known device adapted to send a signal to microprocessor 6. If desired, further digital inputs 14 may be provided, to be used to control other system functions such as changing the score, or to mark the metronomic time of the execution.

A group of digital outputs 16 of microprocessor 6 is connected to the digital signals conditioning stage 15, in output of which there are control signals for auxiliary devices, such as an external electronic metronome 18, and/or for LEDs.

In practice, device 1 is an interface for the acquisition of stroked plaued by a user 100 on a percussion instrument 5.

Nothing would prevent the use, in place of a single sensor 3 for a single percussion instrument 5, of a higher number of sensors 3 for the same percussion instrument 5, so as to simultaneously acquire musical data from multiple percussion instruments 5 using more than one sensor 3.

In the embodiment described in the accompanying Figures, for simplicity, it was chosen to show one sensor 3 only, applied to a single percussion instrument 5.

In a second example of embodiment of device 1 (FIGS. 4-5), the electronic device 9 directly integrates the features which in the example described above were provided by the external computing device 19. The electronic device 9 is associated to a screen or display 25, for example integrated within a tablet making up device 1 as a whole.

In particular, the signal sampled by means of sensor 3 is adapted by means of an analog signal conditioning stage 8, converted by an A/D converter 10 and managed by means of an I/O interface 12.

The signals from the digital inputs 14 and those directed to the digital outputs 16 are managed via the I/O interface 12 through a digital signal conditioning stage 15.

A bus 22 allows the communication between a microprocessor 6, the I/O interface 12, a memory 11, a video controller 23 intended to be connected to screen 25 (for example, a touch screen device of known type) and an audio controller 24 which will be connected to a loudspeaker 26 of known type.

The electronic device 9, in this second embodiment, also comprises a mass memory 51 for the permanent storage of certain data.

In order to use device 1 according to the present invention, a user 100 may implement the procedure represented in the form of a block diagram in FIG. 3, managed by a control software 101, with which user 100 will interact.

The first step of the procedure will be a macro preliminary step 102, comprising in sequence a step 112, in which user 100 will suitably pair sensor 3 to a percussion instrument 5 of which he/she wants to monitor the use.

In the preferred version of device 1, user 100 will also connect I/O interface 12 to a computing device 19, such as a PC (Personal Computer). The latter connection will not be necessary for the second embodiment (FIGS. 4-5), since no external computing device 19 is provided.

At this point, using the control software 101, running on the computing device 19 (FIGS. 1 and 2), or directly on the electronic device 9 (FIGS. 4 and 5), user 100 will perform a configuration step 122 to set a series of operating parameters such as the type of percussion instrument 5 to be monitored, according to the previous positioning of sensor 3 and the dynamics levels, these parameters will also allow the correct adjustment of the analog signal conditioning stage 8.

In a step 132, user 100 will choose the musical sample score PMC to be taken as a reference (or a set of musical sample scores PMC), picking it by means of the control software 101 from a database 50 residing on a mass memory device 51 of known type (hard disk, flash memory or other) present either in the computing device 19 (FIGS. 1 and 2), or in the electronic device 9 (FIGS. 4 and 5), upon setting the metronomic time to be used for the execution of the musical score.

The choice step 132 of user 100 will be followed by a step 142 of loading and translation, made by the control software 101, of the musical sample score PMC, which is selected by the user.

In the case of the device in FIGS. 1 and 2, the PMC will be loaded and displayed on the external computing device 19, after a translation processing, so that the data referring to the ideal temporal location and intensity of the notes, to be taken as a reference, may be used by the same for later comparison.

In the case of the device according to FIGS. 4 and 5, the control software 101 will pick up the musical sample score PMC selected by user 100 in step 132 from database 50 and will load it in the memory unit 11 after a translation processing, so that the data referring to the ideal temporal location of the notes and intensity, to take as reference, are available for the calculations of microprocessor 6.

It should be noted that the translation of the reference score PMC, performed only once for each PMC to be made available to user 100, will result in the transition from musical notation, i.e. the one that is normally used in scores, to a pseudo notation that allows the digitization of the musical score and its correct processing by an automatic system.

For example, considering the score represented by the musical notation below,

a form of pseudo notation that would allow the digitization of the musical score might be the following:
drum cadence in 2/4
anacrusis 1/8
start of tuplet 6:4
1/32 left hand
1/32 left hand
1/32 right hand
1/32 right hand
1/32 left hand
1/32 left hand
end of tuplet
1/8 right hand accented
1/32 left hand
1/32 left hand
1/32 right hand
1/32 right hand
1/8 right hand accented
1/8 accented flam, left hand preceded by piano right hand
1/16 accented flam, right hand preceded by piano left hand
1/16 left hand accented
1/16 right hand
1/16 left hand
1/8 right hand
start of tuplet 3:2
1/8 left hand
1/8 right hand
1/8 left hand
end of tuplet, etc.

The musical notation, which is ideal for its immediacy of understanding by the musician, is not as suitable for the digitization of the musical score, which is instead feasible by means of a pseudo notation of which the example set forth above is a possible methodology.

In step 142, therefore, the control software 101 actually loads in the memory of the external computing device 19 (FIGS. 1 and 2), or in memory 11 (FIGS. 4 and 5), a sequence of data related to musical notes which synthetize, in a form which can be compared with that exposed in advance, the dictate of the score which represents the reference for the execution of the musician. The translation from the score to the data related to the notes, in a form analogous to what described, is performed upstream in the design or expansion step of database 50.

In a step 152 of decoding and temporal location, according to the metronomic time chosen together with the musical sample score PMC in step 132, the musical sample score PMC will in substance be further translated into a sequence of musical events, each associated with evaluation elements such as: stroke temporal location with respect to an initial instant T0, duration calculated with respect to the metronomic time selected by the user during the step 132 (which involvess the extension or contraction of the temporal axis of the execution), laterality (right or left hand), articulation, dynamics level or intensity, etc. The control software 101 will preferably implement an internal metronome 52, by means of which user 100 will set the execution time of the musical score PMS that he/she is going to play.

In case of a percussion instrument 5, duration of notes, dynamics (accents, crescendo, decrescendo, etc.), the hand that plays the note (right or left) and the expression (multiple bounce roll, flam, drag, etc.) will be of primary importance.

Once the macro preliminary step 102 has ended, a macro step 103 will follow for the acquisition of music data of the musical score played PMS: consisting of the execution start step 113 when user 100, for example by operating the remote control 14, will start a system metronome 52 and begin playing the musical score PMS corresponding to the previously chosen musical sample score PMC; meanwhile, the control software 101 will record the musical data during a step 123, detecting them from sensor 3.

Device 1, during the execution of the musical score PMS, which will begin at step 113, i.e. starting from the moment when the internal metronome 52 is started, in step 123 will record the instants in which user 100 has hit the instrument 5 and the intensity of the strokes detected, managing by means of the control software 101, substantially simultaneously, the playback of a metronomic signal, the communication with the hardware, the supervision, the synchronism of I/O 12 and the consequent acquisition and archiving of the strokes played.

In the preferred embodiment (FIGS. 1 and 2), memory 11 is only available to microprocessor 6 and is used by it for the time necessary to transmit the data relating to the beats through the I/O interface 12. Instead, the external computing device 19 will store the data of the various strokes in the mass memory device 51.

In the embodiment in FIGS. 4 and 5, on the other hand, both the processing and the storage functions are all performed by the electronic device 9 via microprocessor 6.

The control software 101 will remain in this acquisition step 103 until, on the basis of the musical sample score PMC, no more strokes are expected to be received or until a time equal to the duration of the musical score PMC has elapsed or until the possible interruption by the user, storing the data of the strokes received from the beginning to the end of the execution of the musical score PMS played by user 100.

At the end of the macro step 103 of data acquisition of the musical score played PMS, a macro evaluation step 104 will begin, during which the strokes detected during the acquisition step 103 are compared with the strokes provided by the musical sample score PMC, i.e. the musical part that is taken as an ideal reference, previously selected by user 100 in step 132 of the preliminary step 102.

In particular, a first comparison is made to verify the stroking instant, i.e. the ideal instant in which the user would have to beat on the percussion instrument 5 is compared with the actual instant in which sensor 3 has detected the stroke played made by user 100 on the percussion instrument 5. The smaller the deviation between the ideal stroking instant and the measured stroking instant, the greater the closeness of the actual execution to the ideal one under the profile of the temporal location of the notes.

A further comparison is made on the intensity of the stroke that user 100 has played on the percussion instrument 5, i.e. the ideal intensity with which the user would have to play a stroke on the percussion instrument 5 is compared with the actual intensity of the stroke played on the percussion instrument 5 and detected by sensor 3. The smaller the deviation between the ideal percussion intensity and the measured percussion intensity, the greater the closeness of the actual execution to the ideal one from the point of view of the intensity of the notes.

Obviously, if during the execution of the played musical score PMS, in addition to the stroking instant and intensity, its laterality and its articulation are detected, having the same values available in the musical sample score PMC, it is possible to make a comparison on these parameters and provide indicators of goodness or deviation between the sample and played musical scores.

At the end of the evaluation phase 104, there will be a presentation step 105 of the processing results, in the preferred version (FIGS. 1-2) making use of an external computing device 19 or, in the device 1 in FIGS. 4-5, displaying the results on screen 25 connected to the video controller 23 of the electronic device 9.

In the preferred version, the electronic device 9, with the aid of the control software 101, during the execution of the musical score PMS, acquires the musical data thereof from sensor 3 and, with the aid of an external computing device 19, can also perform near real-time comparisons described above and send the data of the calculated deviations for displaying them on a screen or display, and store them in the mass memory device 51.

On the contrary, in the version of device 1 in FIGS. 4-5, the electronic device 9 will perform all the processing steps, as well as provide the reports directly on display 25, as mentioned for example of the touch screen type.

The report will consist particularly in the representation of the deviation between the measured data (T, I) of the played musical score PMS and the corresponding ones (Tc, Ic) of the sample musical score PMC. The report will additionally be able to provide a final evaluation based on the preliminary classification of the difficulties attributable to the specific musical phrasings comprised in the sample musical score PMC and on the comparison with the statistic parameters relating to “model” executions of the same musical score by professional musicians.

Once the result presentation step 105 has ended, user 100 will be informed with extreme accuracy about the evaluation parameters that characterize the accuracy of its execution, both in terms of rhythmic precision, i.e. the positioning of the notes in time, and of dynamic accuracy, i.e. the fidelity with which the intensity of its strokes reflects that shown in the selected score. For example, in the presentation phase reports will be produced which comprise inter alia: statistic information (variance, standard deviation, dynamic range of the measured data with respect to PMC), information on the dynamic equilibrium of the two hands (evidencing if the force is homogeneous and/or in agreement with what indicated in the score), particular information on more or less graceful mode of execution of grace-notes, data for classification of the execution and of expression of PMS which will take also into account evaluation criteria associated to the execution of particular rhythmic figures.

If desired, once the presentation stage 105 has ended, software 101 may communicate by means of a network adapter with a network server in order to provide the evaluation data of played musical scores PMS of other users with access to said server and compare them with evaluations obtained by user 100 as a result of his/her execution.

Preferably, the musical data of PMS are stored and then compared with the musical data of the reference musical score PMC in FIFO (First In First Out) mode; timestamps in milliseconds of 4-byte width may be used to store the temporal location of the strokes, able to express the range in milliseconds elapsed from the moment when metronome 52 was started to the instant when a stroke was detected, while values of 1-Byte width may be used for the intensity of the stroke (storing intensity levels ranging from 0 to 255).

In a preferred embodiment, it was verified that in order to obtain a satisfactory degree of precision it is advisable to use a sampling frequency Fc of at least 1 KHz.

It should be noted that, in a device 1 made according to the present invention, the sampling frequency Fc of the signal coming from sensor 3 does not depend in any way on the metronomic time chosen for the internal metronome 52 by user 100 in the preliminary step 102 in the control software 101. The sampling signal resulting from sensor 3 and conditioned by stage 8 uses factors such as intensity and gradient, rising or falling, to deduce whether the beginning or the end of a stroke is being detected and in order to avoid overlap or interference between temporally close fluctuations of the signal which could lead to false detections or loss of detections, it for example uses the comparison with periods of minimum and maximum length of the signal related to a single stroke, set according to the type of percussion instrument 5 selected during the preliminary step 102, which define the overall resolution of the sampling. For example, setting a resolution of 10 ms means that, between the detection of one sample and the next one, a minimum time of 10 ms elapses: this allows fluctuations of signal closer than 10 ms to not adversely affect the sampling of the strokes by giving double detections. Likewise, the period defined by the resolution is set small enough to avoid the loss of detections, with respect to the features of the percussion instrument considered.

The high accuracy obtainable with a frequency of at least 1 KHz is perceived especially during the execution of musical parts with slow times, where the rhythm imprecision is more easily recognizable by the human ear as well: using a too low sampling frequency, or even proportional to the metronomic time, an insufficient resolution would be obtained, due to the discretization introduced by sampling at a low frequency Fc, a situation which would not ensure sampling close to the instant when the stroke reaches the percussion instrument 5.

Using a sufficiently high sampling frequency Fc also allows the evaluation of percussion techniques typically applied to the case of the snare drum, such as the multiple bounce roll, in which an indefinite number of bounces are made for each stroke given by user 100: using a too low sampling frequency Fc, these bounces would certainly not be detected and therefore, the accuracy of execution of the played musical score PMS could not be evaluated. The same phenomenon, with an unsuitable sampling frequency Fc, would occur in the case of flams or drags, in which close notes may not be detected.

In fact, with device 1 for monitoring and evaluating the execution of musical scores for percussion instruments, according to the following invention, a procedure is also defined which allows, starting from one or more reference scores PMC for percussion instruments, the evaluation of the accuracy of a musical part PMS by a user 100 substantially in real time.

The evaluation will be mainly, but not exclusively, intended to highlight which instant T of execution of each stroke is with respect to the initial instant T0 of the execution and/or with respect to the previous/next stroke, and to detect intensity I of the same, so that these data are comparable with those of the musical score selected as a sample PMC, or in other words to evaluate the quality of the execution of the musical score PMS played by user 100.

At the end of the procedure, user 100 can verify the quality of his/her execution by consulting the reports available, through which device 1 will provide numerous indicators relating to the quality of the execution by user 100 compared with both the musical sample score PMC and with musical scores PMS played previously and stored by device 1.

In the practice, the materials used as well as the sizes, may be whatever, according to the requirements.

1. A device for monitoring the accuracy of use of percussion instruments suitable for the execution of musical scores (PMS) comprising musical data (T, I), wherein it comprises a sensor intended to be coupled to a percussion instrument to detect musical data (T, I) of a musical score (PMS) played by a user with said instrument and an electronic device adapted for sampling, at a sampling frequency Fc, the musical data (T, I) detected by said sensor, said musical data (T, I), comprising the detecting instant (T) of each note with respect to an initial instant T0 taken as a reference and the intensity (I) of each played note, for storing said data (T, I) sampled during the execution of the musical store (PMS) in a memory device, transmitting them through am I/O interface to an external computing device this electronic device being intended to compare the data (T, I) relating to the musical execution (PMS) with those (Tc, Ic) relating to a sample musical score (PMC) or arbitrary complexity and extension selected by a user which is also allowed to select arbitrarily the metronomic time of the execution of the same score and to visualize the results of such comparisons, comprising numeric, statistic and descriptive representation derived from the deviation between the measured musical data (T, I) and the corresponding ones (Tc, Ic) of the sample score (PMC).

2. A device for monitoring the accuracy of use of percussion instruments suitable for the execution of musical scores (PMS) comprising musical data (T, I), wherein it comprises a sensor intended to be coupled to a percussion instrument to detect musical data (T, I) of a musical score (PMS) played by a user with said instrument and an electronic device comprising a microprocessor adapted for sampling, at a sampling frequency Fc, the musical, data (T, I) detected by said sensor, said musical data (T, I), comprising the instant (T), detected with respect to an initial instant T0 taken as a reference and the intensity (I) of each stroke which reaches said percussion instrument during the execution of a musical score (PMS) played by a user, and able to manage processing and storing of said musical data (T, I) in a memory device, a data base contained in a mass memory unit containing at least one musical sample score (PMC) of arbitrary complexity and extension selectable by a user which is also allowed to select arbitrarily the metronomic time of the execution of the same score, destined to be considered a reference score, said microprocessor being able to compare said musical data (T, I) detected, by said sensor during the execution of a played musical score (PMS) by a user with the corresponding musical data (Tc, Ic) of said sample musical score (PMC), taken as a reference, and to provide results of comparisons of (Tc, Ic) with (T, I) which comprise numeric statistic and descriptive representation derived from the deviation between the measured musical data (T, I) and the corresponding ones (Tc, Ic) of the sample musical score (PMC).

3. The device according to claim 1, wherein sampling frequency Fc of detected musical data (T, I) by the sensor is independent from the metronomic time of execution of the played musical score (PMS) to be monitored.

4. The device according to claim 1, wherein sampling frequency Fc of musical data (T, I) detected by sensor has a value of at least 1 KHz.

5. The device according to claim 1, wherein said sensor is linked upstream of an analogical signal conditioning stage, downstream or which an A/D converter stage is linked which communicates with said microprocessor, said stage being intended to adapt the characteristics of the signals coming from said sensor in order to render them suitable for correct processing by said A/D converter stage, allowing the correct conversion into measured musical data (T, I).

6. The device according to claim 1, wherein said microprocessor comprises digital outputs, able to drive external devices, linked via an intermediate conditioning stage of the digital signals.

7. The device according to claim 1, wherein it comprises digital inputs, suitable to receive signals from at least one remote control interfaced with said microprocessor via a digital signal conditioning stage.

8. A procedure to monitor and evaluate a musical score PMS execution for percussion instruments according to the following invention, comprising:
a macro preliminary step includes
a coupling step of a sensor linked to am electronic device to a percussion instrument, by a user;
an initial configuration step of operating parameters according to the type of percussion instrument, the dynamics levels and the type of musical score to be monitored;
a choice step, by of a user, the musical part sample (PMC) to be executed and the metronomic tempo, eventually signalled by an internal metronome, that will be used for the execution of a musical part played (PMS) by the user;
a collecting step of the musical sample score (PMC) chosen in step from a database and made available for the next steps;
a decoding and translation step of the musical sample score (PMC) selected at step, which according to the metronomic time chosen in the same-step, will lead to the compilation of a sequence of musical events wherein evaluation elements such as the temporal location (T) with respect to an initial time (T0), the intensity (I), the duration, the hand to be used and the articulation of each stroke;
a macro acquisition phase of musical data comprising
an execution start of the musical sample score (PMC);
a recording step of musical data (T, I) relating to the musical score played (PMS) by the user, iterated throughout the whole expected duration of the musical sample score (PMC);
an evaluation step of the musical data (T, I) obtained in the macro acquisition step by computing the differences between the musical data (T, I) measured relative to the musical score played (PMS) compared to the corresponding musical data (Tc, Ic) of the musical sample score (PMC);
a stage of presentation of results.

9. (canceled)

10. The device according to claim 1, wherein to be governed by a control software allowing to communicate by means of a network adapter with a network server, in order to make available evaluation data of musical score played by other users (PMS) accessing to said server.

11. The device according to claim 1, wherein being able to provide results of processing (Tc, Ic) of relative to the sample musical score (PMC) compared with (T, I) relative to the played musical score (PMS), which comprise the final evaluation of the played musical score (PMS) through preliminary classification of the difficulties attributable to specific musical phrasings of the sample musical score (PMC) and comparison with the statistic parameters relative to “model” executions of the same musical part by professional musicians.
